(19) United States
(12) Patent Application Publication
(10) Pub. No.: US 2008/0288307 A1
(43) Pub. Date: Nov. 20, 2008

(54) PROJECT MANAGEMENT SUPPORT DEVICE AND METHOD THEREOF

(76) Inventors: Kaoru Kawabata, Ibaraki (JP); Takeshi Yokota, Ibaraki (JP); Kenji Araki, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/019,659

(22) Filed: Jan. 25, 2008

(30) Foreign Application Priority Data
Mar. 23, 2007 (JP) 2007-076487

(51) Int. Cl. G06Q 10/00

(52) U.S. Cl. 705/7

(57) ABSTRACT

Disclosed is a project management support device which compares, when a project is planned, standard work information stored in a standard work information database 21 with work information planned based on the standard work information according to a project target or a project condition, displays added or omitted work information extracted from the comparison and information to be noted which is related to the added or omitted work information on a display device 4. The project management support device further compares, during implementation of the project, the standard work information stored in the standard work information database 21 with work information changed based on progress or a state of the work in the project, and displays the added or omitted work information extracted from the comparison and information to be noted which is related to the added or omitted work information on the display device 4.

### CROSS REFERENCE TO RELATED APPLICATIONS

This application claims the foreign priority benefit under 35 U.S.C. §119 of Japanese Patent Application No. 2007-076487 filed on Mar. 23, 2007, the disclosure of which is incorporated herein by reference.

### BACKGROUND OF THE INVENTION

1. Field of the Invention

The present invention relates to a project management support device and a project management support method for supporting a user to manage a project work plan when the user makes the project work plan and also when the project work plan is implemented.

2. Description of the Related Art

Knowing what kind of works are needed in each process in a project and what kind of information is required for each work is useful for dodging and reducing a risk in the project. In this specification, a “project” means an activity which has a clear-cut start point and end point to obtain deliverables or services, such as a program development.

As a method for managing works in a project, conventionally there are a document management system and a work management support system for encouraging and leading implementation of a project by integrally managing a work structure of the project, presentation of documents and tools required for works in the project and deliverables obtained by the work.

As a method for changing information related to a process in a project when the process is changed in a progress management of the project, Japanese Laid-Open Patent Publication No. 2003-345956 (paragraph “0008” to “0009”, FIG. 1) discloses a technique which calculates an influence exerted by a change in a process in a project on other processes according to probability distribution data, and Japanese Laid-Open Patent Publication No. 2006-72413 (paragraph “0006” to “0011”, FIG. 3) discloses a technique which calculates how far a project has been progressed based on the degrees of significance and progress of each work in the project.

In accordance with conventional project work plan management methods including the techniques disclosed in the Japanese Laid-Open Patent Publication No. 2003-345956 and the Japanese Laid-Open Patent Publication No. 2006-72413, when a certain process in a project is changed, influence quantity of a duration and a cost affecting other processes or those of the entire project is evaluated based on the standard work processes experientially accumulated, so as to reflect this influence quantity in a project work plan.

In the conventional project work plan management methods, however, a support mechanism is not provided for supporting a user to decide whether or not to add or omit a work when the user (e.g. project manager) makes a project work plan that suites a project object or a project condition based on standard work processes. Also a support mechanism is not provided for presenting information to be noted and supporting the user to determine whether or not to add or omit a work in response to work information changed based on progress of a work or a state of the work during implementation of the project.

### SUMMARY OF THE INVENTION

The present invention is made in view of the above problems, and an object thereof is to provide a project management support device and a project management support method which enable to support a user to determine whether or not to add, omit or change a work in a project and improve the usability thereof.

The project management support device according to the present invention compares, when a project is planned, standard work information stored in a storage device with work information generated based on the standard work information according to a project target or a project condition, displays omitted work information and added work information extracted from a result of the comparison and information to be noted which is related to the work information changed from the standard work information on a display device. The project management support device according to the present invention also compares the standard work information stored in the standard work information data base with work information which is changed based on progress of a work or a state of the work, and displays deleted work information, the omitted work information and the added work information extracted from a result of the comparison together with information to be noted which is related to the deleted work information, the omitted work information, the added work information or the work information changed based on progress of the work or the state of the work. Thus, the project management support device according to the present invention provides a user information for determining whether or not to delete, add or change a work.

A first aspect of the present invention provides a project management support device for managing work information in each process in a project and attribute information in the work information, including an input device for inputting information, a storage device for storing standard work information of the project, a display device, and an arithmetic processing device for comparing the work information acquired via the input device when the project is planned with the standard work information stored in the storage device, extracting added work information or omitted work information from a result of the comparison, and displaying the extracted work information on the display device.

A second aspect of the present invention provides a project management support device for managing work information in each process in a project and attribute information in the work information, including an input device for inputting information, a storage device for storing standard work information of the project, a display device, and an arithmetic processing device for comparing the work information changed during implementation of the project based on information on progress of a work or a state of the work acquired by the input device with the standard work information stored in the storage device, extracting added work information or omitted work information from a result of the comparison, and displaying the extracted work information on the display device.

A third aspect of the present invention provides a project management support method implemented in a project management support device including an input device for inputting information, a storage device for storing standard work information of a project and a work attribute information changing rule according to which attribute information in work information is changed, an arithmetic processing device and a display device, the method allowing the arithmetic processing device to perform the steps including a first step of acquiring a project work plan input via the input device, a second step of retrieving the standard work information stored in the storage device, a third step of comparing the project work plan with the standard work information, extracting omitted work information and added work information from a result of the comparison and displaying the omitted work information and the added work information on the display device, a fourth step of acquiring information on progress of a work or a state of the work input via the input device, a fifth step of referring to the work attribute information changing rule based on the acquired information on progress of the work or the state of the work, and performing processing for changing the work information according to the work attribute information changing rule, and a sixth step of comparing the work information changed by the processing for changing the work information with the standard work information, extracting omitted work information and added work information from a result of the comparison, and displaying the omitted work information and the added work information on the display device.

Other features and advantages of the present invention will become more apparent from the following detailed descriptions of the invention when taken in conjunction with the accompanying drawings.

### BRIEF DESCRIPTION OF THE DRAWINGS

FIG. 1 is a block diagram showing a basic configuration of a project management support device according to the embodiment of the present invention.

FIG. 2 is a flow chart showing a basic operation of the project management support device according to the embodiment of the present invention.

FIG. 3 is a flow chart showing a detailed operation of Step S304 shown in FIG. 2.

FIG. 4 is an example data structure of the standard work information database shown in FIG. 1.

FIG. 5 is an illustration showing an example data format of reference information of the standard work information shown in FIG. 4 and categories of the reference information.

FIG. 6 is an example data format of work information in a project work plan.

FIG. 7 is an example data format of reference information of the work information in the project plan shown in FIG. 6.

FIG. 8 is an example data format of work information during implementation of a project.

FIG. 9 is an example data structure of the work attribute information changing rule database shown in FIG. 1.

FIG. 10 is an illustration showing an example data format of reference information of the work information during implementation of the project, and categories of the reference information

FIG. 11 is an example data format of work information during implementation of a project.

FIG. 12 is an example data structure of the work attribute information changing rule database shown in FIG. 1.

FIG. 13 is an illustration showing an example data format of reference information of the work information during implementation of the project, and categories of the reference information

FIG. 14 is an example of a screen structure displayed by the project management support device according to the embodiment of the present invention when the project is planed.

FIG. 15 is an example of a screen structure displayed by the project management support device according to the embodiment of the present invention while the project is implemented.

### DETAILED DESCRIPTION OF THE INVENTION

Embodiment of the present invention will be explained below with reference to the accompanying drawings.

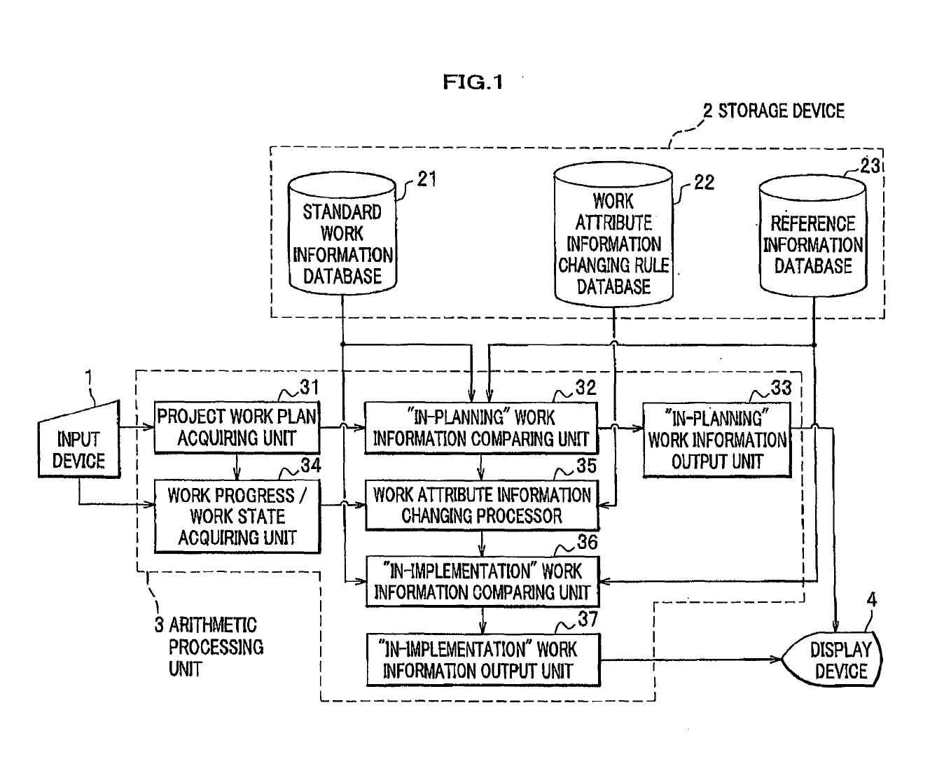

FIG. 1 is a block diagram showing a basic configuration of a project management support device according to the embodiment of the present invention.

The project management support device according to the embodiment of the present invention includes an input device 1 such as a keyboard and a mouse, a storage device 2 such as a hard disk, an arithmetic processing unit 3 configured by a CPU (Central Processing Unit) and memory and the like, and a display device 4 such as a monitor.

Stored in the storage device 2 are a standard work information database 21, a work attribute information changing rule database 22, a reference information database 28. The standard work information database 21 stores information on works to be carried out in each process in a project and attribute information of the works. The work attribute information changing rule database 22 records work attribute information changing rules for changing, when work information is changed, the attribute information of a work which is related to the work information. The reference information database 23 stores information related to each work, for example, information on contracts and the like.

The arithmetic processing unit 3 includes, as shown in its developed internal structure, a project work plan acquiring unit 31, an “in-planning” work information comparing unit 82, an “in-planning” work information output unit 33, a work progress/work state acquiring unit 34, a work attribute information changing processor 35, an “in-implementation” work information comparing unit 36, and an “in-implementation” work information output unit 37.

A project work plan acquiring unit 31 acquires a project work plan (e.g. a process in a project that is planned by a user such as a project manager according to a type of the project (e.g. country, product, customer) and information on works to be carried out in each process), input by the input device 1 and provides the project work plan with the “in-planning” work information comparing unit 32.

Information output from the standard work information database 21, the reference information database 23 is also provided with the “in-planning” work information comparing unit 32. The “in-planning” work information comparing unit 32 compares each piece of work information in the project work plan with standard work information recorded in advance in the standard work information database 21, and further compares reference information of the work information in the project work plan with reference information of the standard work information. Then, the “in-planning” work information comparing unit 32 outputs a result from the above comparison to the “in-planning” work information output unit 33 and the work attribute information changing processor 35 as “added work information” or “omitted work information”. The “in-planning” work information output unit 33 has a function that generates display information based on the omitted work information and the added work information provided from the “in-planning” work information comparing unit 32, and outputs the generated display information to the display device 4.

The work progress/work state acquiring unit 34 acquires information on progress of a work or a state of the work which is input by the input device 1 (e.g. information indicating whether a work in the project is completed or not, information indicating a quality level of the work and information indicating whether or not there is a prepared document), and provides the information on progress or a state of the work for the work attribute information changing processor 35. Also provided for the work attribute information changing processor 35 is information output from the work attribute information changing rule database 22. The work attribute information changing processor 35 refers to a work attribute information changing rule stored in the storage device 2 based on the information on the progress or the state of the work acquired by the work progress/work state acquiring unit 34, and changes attribute information of a work which is related to the information on the progress of the work or the state of the work acquired by the work progress/work state acquiring unit 34, and outputs the changed attribute information to the “in-implementation” work information comparing unit 36.

In this explanation, “attribute information of a work” denotes a name of a work, a content of the work, a structure of the work, significance or priority of the work, information on progress of the work or on a state of the work, reference information on the work and the like. “Work attribute information changing rule” is information showing an influence that progress or a state of the work exerts on other works, and attribute information of a work is changed according to the work attribute information changing rule during implementation of the project. “Influence” used hereinafter means a change in attribute information of a work, which results in a deletion of the work, a change in significance (a risk level or necessity level) or priority degree of the work.

The “in-implementation” work information comparing unit 86 compares work information generated when the project is planned, attribute information changed by the work attribute information changing processor 35 with the standard work information stored in advance in the standard work information database 21, and further compares reference information of the work information with the reference information of the standard work information output by the reference information data base 23. The “in-implementation” work information comparing unit 36 extracts “added work information” and “omitted work information” as a result of the comparison, and outputs the extracted information to the “in-implementation” work information output unit 37.

The “in-implementation” work information output unit 37 has a function that generates display information based on the omitted work and the added work provided from the “in-implementation” work information comparing unit 36, and outputs the generated display information to the display device 4.

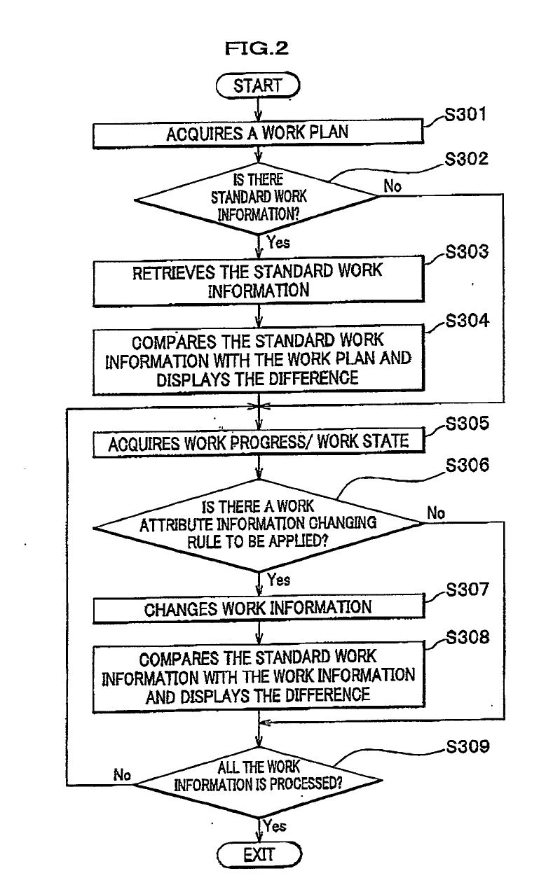

FIG. 2 is a flow chart showing a basic operation of the project management support device according to the embodiment of the present invention.

The basic operation of the project management support device according to the embodiment of the present invention shown in FIG. 1 is explained with reference to the flow chart shown in FIG. 2.

A project manger (i.e. a user) operates the input device 1 to input project work plan information, and then the arithmetic processing unit 3 acquires the project work plan information. The arithmetic processing unit 3 acquires the input project work plan information via the project work plan acquiring unit 31 (Step S301), and then provides the project work plan information for the “in-planning” work information comparing unit 32. At this time, the “in-planning” work information comparing unit 32 determines whether or not standard work information which corresponds to the project work plan information is recorded in the standard work information database 21 in the storage device 2 (Step S302), and if it is determined that the standard work information is recorded (“Yes” at the Step S302), the “in-planning” work information comparing unit 32 retrieves the standard work information (Step S303).

Then, the “in-planning” work information comparing unit 32 compares the acquired project work plan information with the retrieved standard work information. If the acquired project work plan information and the retrieved standard work information is determined to be different by the comparison, the “in-planning” work information comparing unit 32 extracts difference between the acquired work plan information and the retrieved standard work information as omitted work information and added work information, and outputs the omitted work information and the added work information to the “in-planning” work information output unit 33 (Step S304). The “in-planning” work information output unit 33 generates display information based on the input omitted work information and the added work information, and displays the display information on the display device 4. An example of a screen structure displayed on the display device 4 at this time is shown in FIG. 14. Details of the screen structure will be explained later.

On the other hand, the project manger operates the input device 1 to set and input information on progress of the work (e.g. whether or not a work is completed) or a state of the work during execution of the project work plan. The input information is acquired by the work progress/work state acquiring unit 34 of the arithmetic processing unit 3 and provided with the work attribute formation changing processor 35 (Step S305).

Then, the work attribute information changing processor 35 refers to the work attribute information changing rule data base 22 in the storage device 2 based on the input information acquired by the work progress/work state acquiring unit 34 (Step S306). If there is a work attribute information changing rule to be applied to the input information (“Yes” at the Step S306), the work attribute information changing processor 35 executes a process for changing work information which is a subject of the work attribute information changing rule (Step S307). This process is performed by changing the attribute information in the work information.

The project manger predefines, for example, significance of a work, a priority and before-and-after relationship of the work that indicates a relationship of the work and another work as the attribute information. A result of the process for changing the work information is provided with the “in-implementation” work information comparing unit 36.

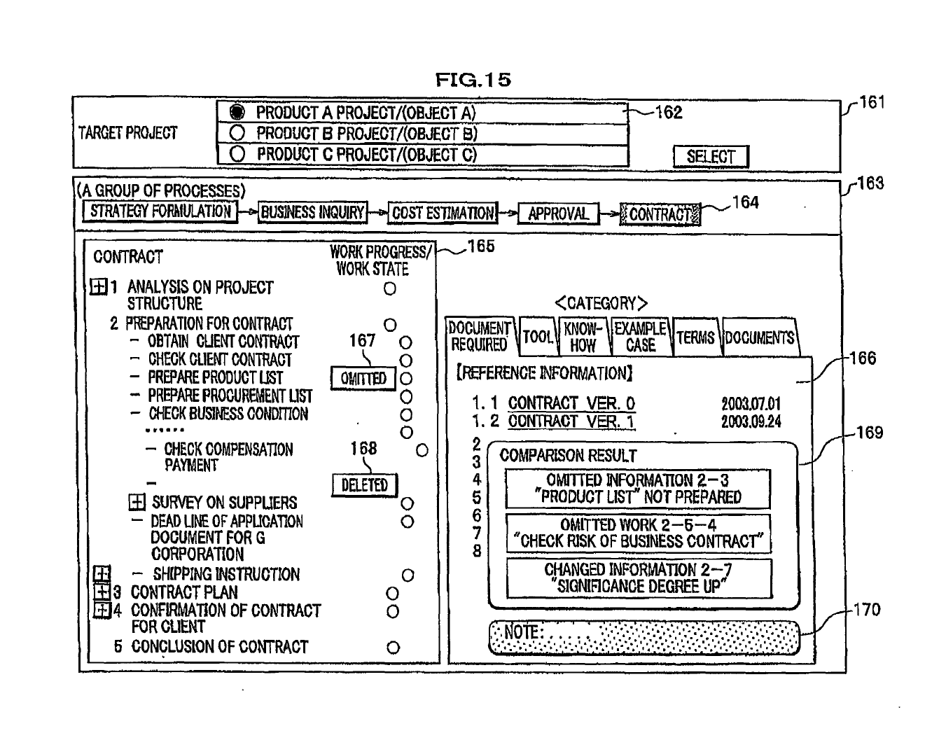

The “in-implementation” work information comparing unit 36 compares the work information changed based on the attribute information output from the work attribute information changing processor 35 with the standard work information recorded in the standard work information database 21, and further compares reference information of the work information with the reference information of the standard work information recorded in the reference information data base 23, and displays a comparison result on the display device 4 via the “in-implementation” work information output unit 37 (Step S808). An example of a screen structure displayed on the display device 4 at this time is shown in FIG. 15. Details of the screen structure will be explained later.

The processing described above is performed repeatedly on all work information in the project work plan (“No” at Step S309). When the processing is performed on all the work information (“Yes” at the Step S309), the processing is terminated.

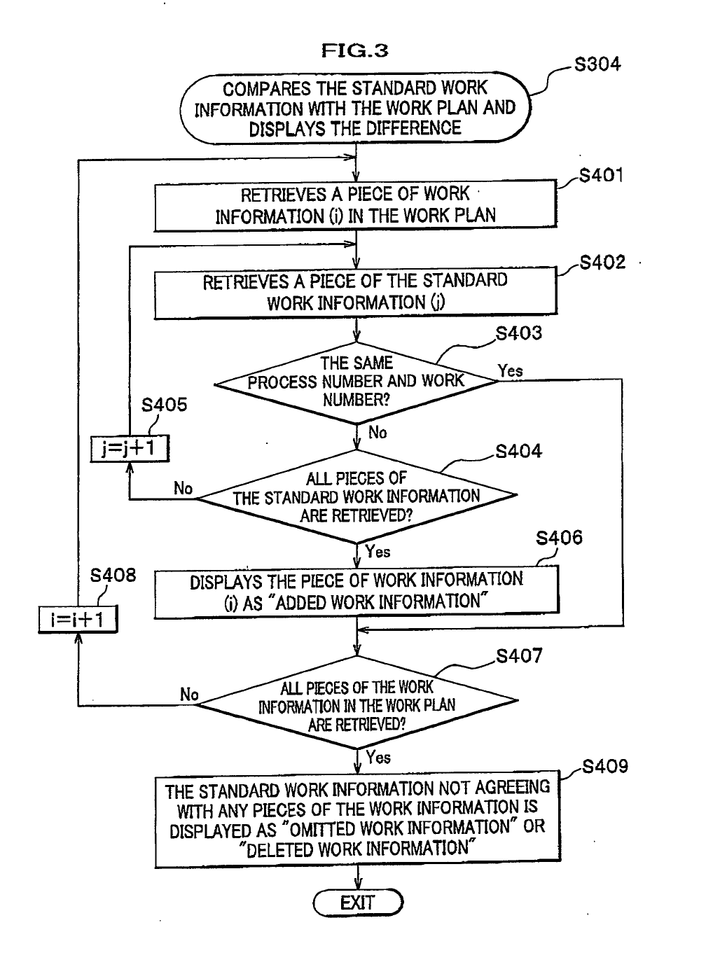

FIG. 3 is a flow chart showing the steps performed in the processing executed by the arithmetic processing unit 3 (the “in-planning” work information comparing unit 32) for comparing the project work plan information with the standard work information (Step S304 in FIG. 2).

When a project manager adds work information which is not included in the standard work information to the project work plan information, the “in planning” work information comparing unit 32 displays the added work information on the display device 4 via the “in-planning” work information output unit 33. When the project manager omits work information which is included in the standard work information, the “in-planning” work information comparing unit 32 displays the omitted work information via the “in-planning” work information output unit 33.

In the flow chart shown in FIG. 3, the project work plan acquiring unit 31 acquires a piece of work information in the project work plan (i) input via the input device 1 (Step S401). The “in-planning” work information comparing unit 32 compares the project work plan information acquired by the project work plan acquiring unit 31 with the standard work information (j) recorded in the standard work information database 21 in the storage device 2 (Step S402), and searches for the same work information (Step S403).

The work information is predefined to be recognized as the same work information if a process number and an item number in the work information is the same (“Yes” at the Step S403).

It is more preferable to determine whether or not the work information is the same based on a similarity degree of the work information compared using vectorial distance. When the work information is compared with all the standard work information and there is no standard work information which agrees with the work information regarding the work, (“Yes” at Step S404), the “in-planning” work information comparing unit 32 determines that the piece of the work information is added, and displays the work information as “added work information” on the display device 4 via the “in-planning” work information output unit 33 (Step S406).

The “in-planning” work information comparing unit 32 adds one (+1) to identification number of the work information acquired by the project work plan acquiring unit 31 (Step S408), and executes the processing of the Step S401 and the subsequent steps repeatedly on all the work information to compare all the work information one by one with all the standard work information recorded in the standard work information database 21 (until “Yes” at the Step S407). If there is the standard work information which is determined not to agree with any of the work information, the “in-planning” work information comparing unit 32 determines that the standard work information is omitted, and displays the standard work information as “omitted work information” on the display device 4 via the “in-planning” work information output unit 33 (Step S409).

Data structures of the standard work information, the reference information, the project work plan information, the work attribute information changing rule are explained in detail below.

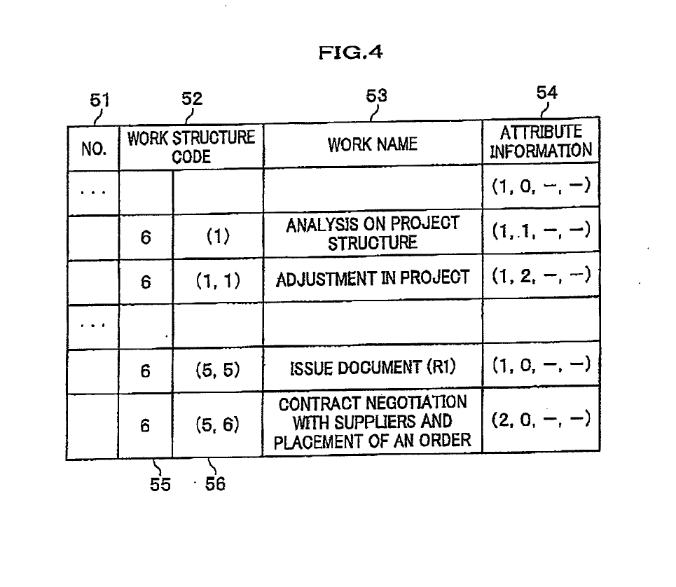

FIG. 4 shows an example of the standard work information recorded in the standard work information database 21 in the storage device 2.

Each standard work information is composed of a work number (51), a work structure code (52) which represents a work structure, a work name (53), and attribute information (54). The work structure code (52) is represented by a process number (55) and an item number (56). For example, the work structure code of “ADJUSTMENT IN PROJECT(1)” indicates that “ADJUSTMENT IN PROJECT(1)” is a middle item number 1.1 under a top item number 1 (ANALYSIS ON PROJECT STRUCTURE) in a process 6. In this embodiment, a significance degree, a precedence degree, a progress degree, and a state of a work and the like are defined as the attribute information (54). For example, the attribute information of “CONTRACT NEGOTIATION WITH SUPPLIERS AND PLACEMENT OF AN ORDER” indicates that “CONTRACT NEGOTIATION WITH SUPPLIERS AND PLACEMENT OF AN ORDER” has the significance degree of “2” and the antecedent degree of “0” (meaning there is no work related). The progress degree and the state of the work are left blank in the standard work information.

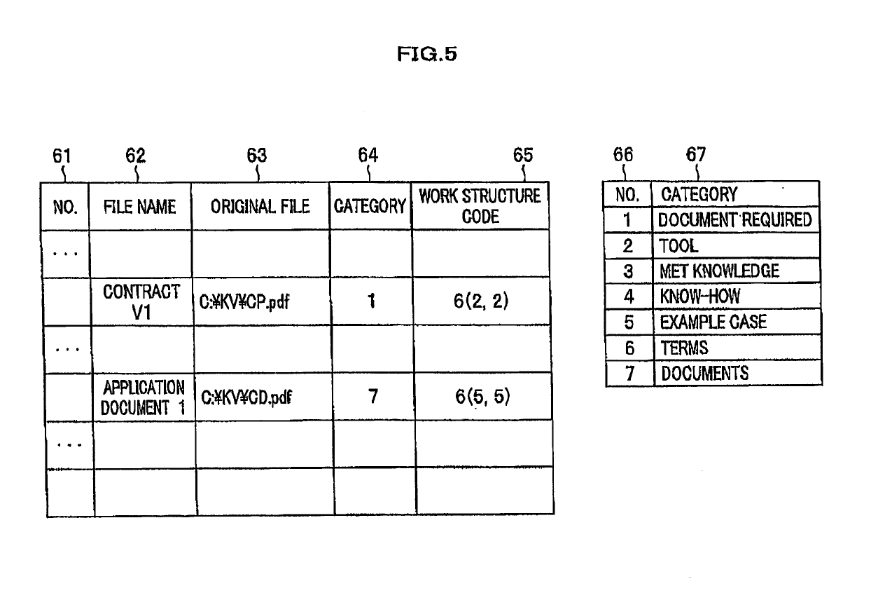

FIG. 5 is an example of reference information of the standard work information shown in FIG. 4. A file in the reference information shown in FIG. 5 is composed of a file number (61), a file name (62), an original file which is shown with its address (63), a category indicating the type of the file (64) (refer to a table which is composed of a category number 66 and a category name 67), and a work structure code (65) indicating which work shown in FIG. 4 is related to the file.

For example, the reference information in FIG. 5 shows that “CONTRACT V1” is “a document required” for the work “2.2 in the process 6” and a file to be referred to exists in “C:¥KV¥CP.pdf”. Similarly, the reference information shows that “APPLICATION DOCUMENT 1” is “a document prepared” for the work “5.5 in the process 6”, and a file to be referred to exists in “C:¥KV¥CD.pdf”

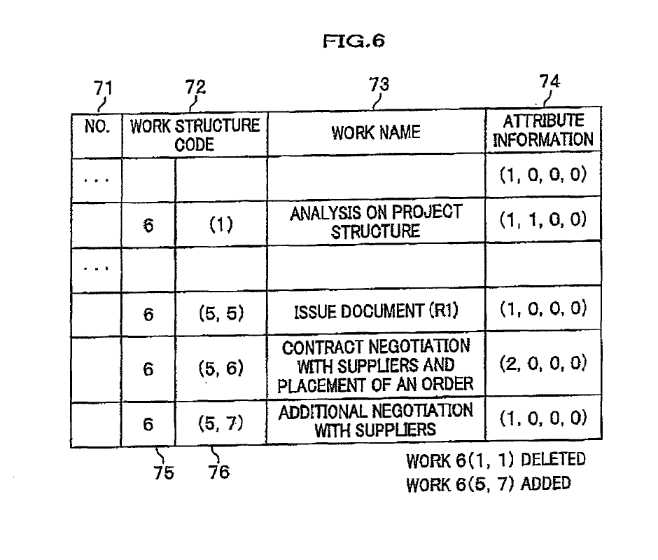

FIG. 6 is an example of work information in the project work plan. Similarly to the standard work information shown in FIG. 4, the work information in the project work plan shown in FIG. 6 is composed of a work number (71), a work structure code (72) which represents a work structure, a work name (73), and attribute information (74). The work structure code (72) is represented by a process number (75) and an item number (76). For example, the work structure code of “ISSUE DOCUMENT (R1)” indicates that “ISSUE DOCUMENT (R1)” is a middle item number 5.5 under a top item number 5 in the process 6. In this embodiment, a significance degree, a precedence degree, a progress degree and a state of a work and the like are defined as the attribute information (74). For example, the attribute information of “ADDITIONAL NEGOTIATION WITH SUPPLIERS” indicates that “ADDITIONAL NEGOTIATION WITH SUPPLIERS” has the significance degree of “1” and the antecedent degree of “0” (meaning there is no work related). The progress degree and the state of the work are left blank because the project work plan is just planned.

When the “in-planning” work information comparing unit 32 compares the project work plan information with the standard work information (refer to FIG. 4), the “in-planning” work information comparing unit 32 determines that “the work 1.1 in the process 6” is omitted and “the work 5.7 in the process 6” is added, and displays the added work information and the omitted work information on the display device 4 via the “in-planning” work information output unit 33.

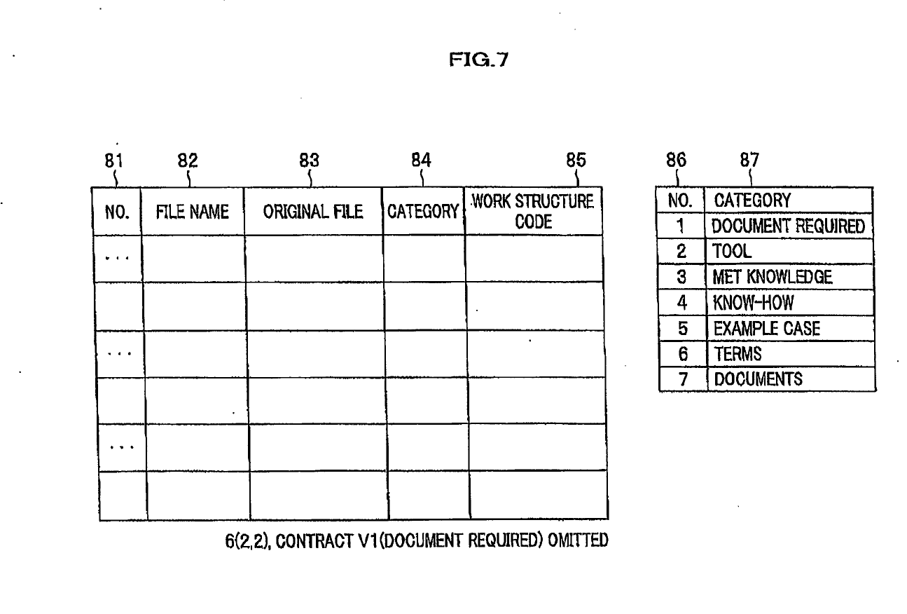

FIG. 7 is an example of reference information of the work information in the project work plan in FIG. 6. Similarly to the reference information of the standard work information shown in FIG. 5, each piece of the reference information of the work information in the project work plan shown in FIG. 7 is composed of a mile number (81), a file name (82), an original file which is shown with its address (83), a category indicating the type of the file (84) (refer to a table which is composed of a category number 86 and a category name 87), and a work structure code (85) indicating which work shown in FIG. 6 is related to the file.

FIG. 7 shows that there is no reference information.

When the “in-planning” work information comparing unit 32 compares the required document in the reference information of the work information and the required document of the reference information of the standard work information, the “in-planning” work information comparing unit 32 determines that “(CONTRACT V1) for the work 2.2 in the process 6 is omitted”, and displays this comparison result on the display device 4 via the “in-planning” work information output unit 33. An example of a screen structure displayed at the time when the project is planned is shown in FIG. 14. Details of the screen structure will be described later.

In accordance with the project management support device according to the embodiment of the present invention, the arithmetic processing unit 3 compares the work information generated when the project is planned with the standard work information, and displays the difference therebetween, whereby it is possible to support the project manager to determine whether or not to add or omit a work when the project manager plans the project, which contributes to streamlining works of the project and analyzing risk countermeasures.

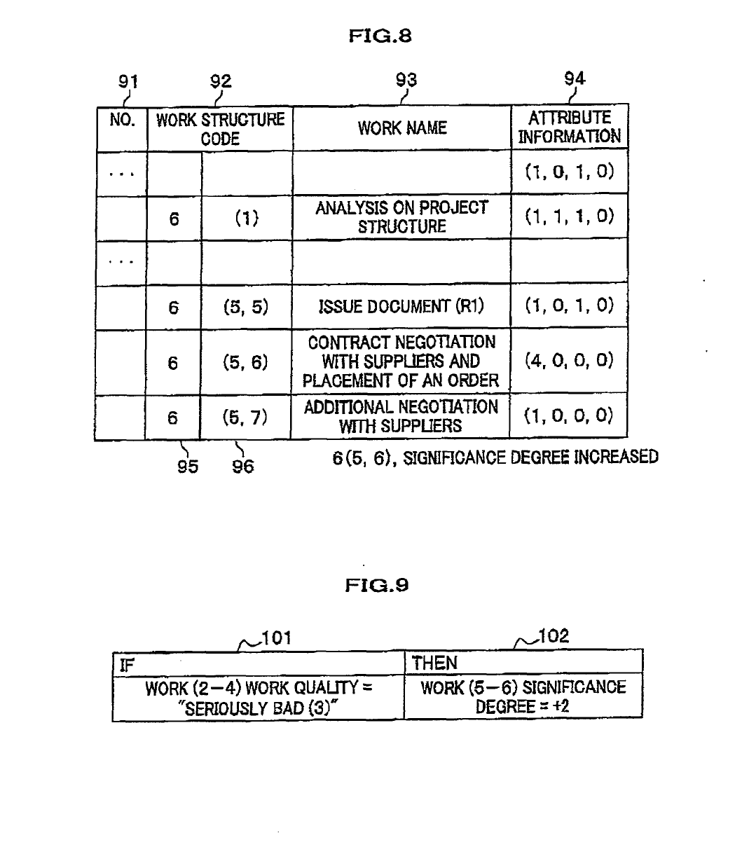

FIG. 8 is an example of work information during implementation of the project. Similarly to the standard work information of the standard work shown in FIG. 4, each piece of the work information shown in FIG. 8 is composed of a work number (91), a work structure code (92) which represents a work structure, a work name (93), and attribute information (94). The work structure code (92) is represented by a process number (95) and an item number (96). For example, the work structure code of “ADJUSTMENT IN PROJECT(1)” indicates that “ADDITIONAL NEGOTIATION WITH SUPPLIERS” is a middle item number 5.7 under a top item number 5 in the process 6. In this embodiment, a significance degree, a precedence degree, a progress degree and a state of a work and the like are defined as the attribute information (94). For example, the attribute information of “ANALYSIS ON PROJECT STRUCTURE” indicates that the significance degree is “1” and the antecedent degree is “1” (meaning there is a work related), the stage of completion is “1(completed)” and the state of the work is “0(no problem)”.

FIG. 9 is an example of the work attribute information changing rule which is referred to during implementation of the project. The work attribute information changing rule is recorded in the work attribute information changing rule data base 22 in the storage device 2. The work attribute information changing rule is composed of an IF unit (101) for determining a state of a work completed and a THEN unit (102) for performing processing for changing attribute information in work information if a condition of the IF unit is met.

The example shown in FIG. 9 shows that “the significance degree of the work 5-6 is increased by 2” if “the work quality of the work 2-4 is seriously bad (3)”. The processing for changing the attribute information is executed according to the work attribute information changing rule.

When a work is completed during implementation of the project, the work attribute information changing processor 35 refers to the work attribute information changing rule data base 22 in the storage device 2 to determine whether or not there is a work attribute information changing rule which is related to the work. If attribute information of the work meets a condition of the work attribute information changing rule, the work attribute information changing processor 35 changes attribute information of another work according to the work attribute information changing rule. Then, similarly to the “in-planning” work information comparing unit 32, the “in-implementation” work information comparing unit 36, which is explained later, compares the work information in the project work plan with the standard work information.

The “in-implementation” work information comparing unit 36 compares the attribute information of the completed work with the standard work information (refer to FIG. 4). In the case shown in FIG. 9, it is determined that “the significance degree of the work 5.6 in the process 6 is increased”, and this comparison result is displayed on the display device 4 via the “in-implementation” work information output unit 37.

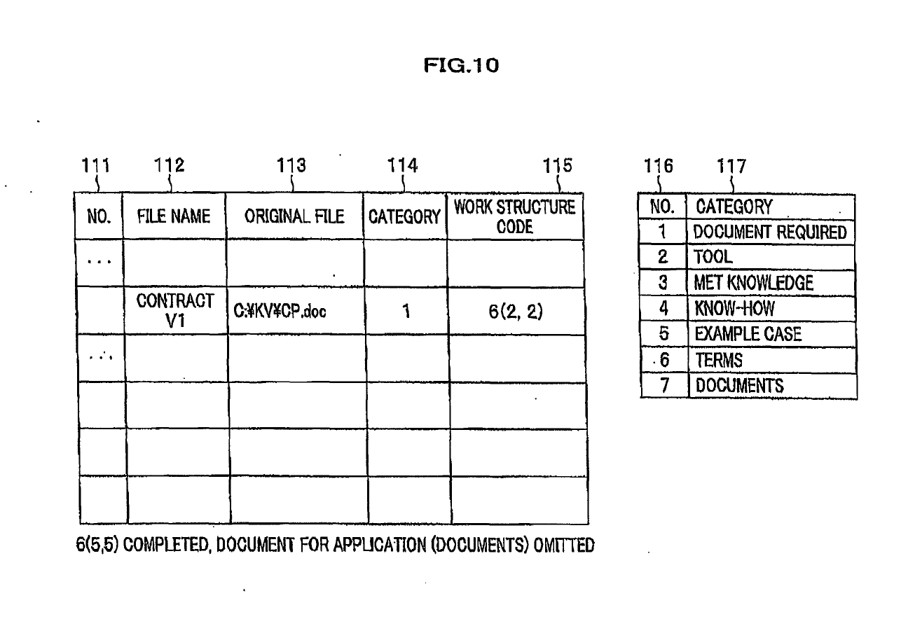

FIG. 10 is an example of reference information of the work information during implementation of the project shown in FIG. 8. Each piece of the reference information of the work information during implementation of the project shown in FIG. 8 is composed of a file number (111), a file name (112), an original file which is shown with its original file (113), a category indicating the type of the file (114) (refer to a table which is composed of a category number 116 and a category name (117), and a work structure code (115) indicating which work shown in FIG. 8 is related to the file.

When a prepared document in the reference information of the work information during implementation of the project is compared with prepared documents in the reference information of the standard work information refer to FIG. 5), it is determined that “application document 1 for the work 5.5 in the process 6 is omitted”, and this comparison result is displayed on the display device 4.

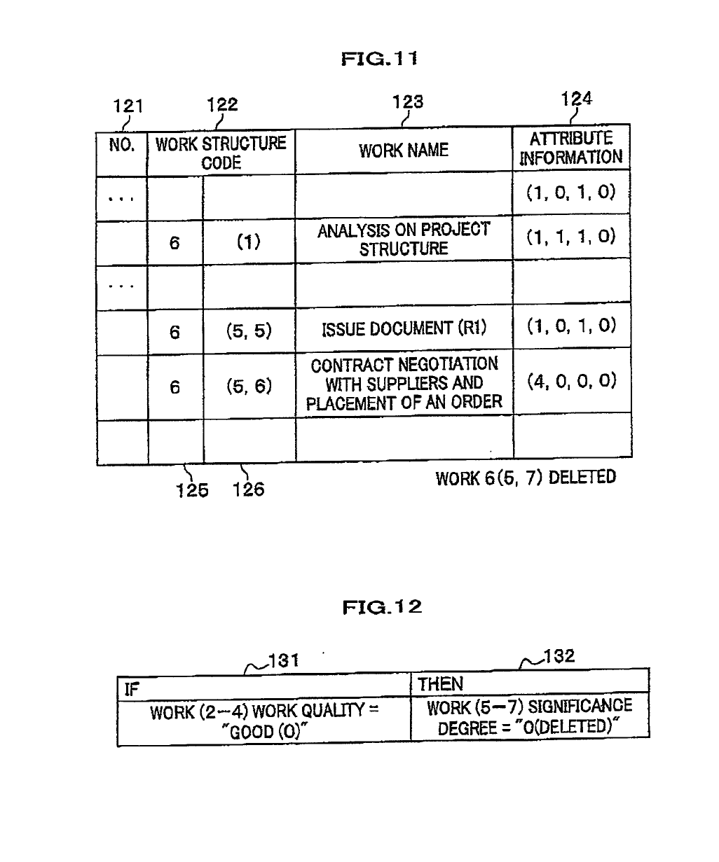

FIG. 11 is another example of the work information during implementation of the project. Similarly to the standard work information shown in FIG. 4, each piece of the work information shown in FIG. 11 is composed of a work number (121), a work structure code (122) which represents a work structure, a work name (123), and attribute information (124). The work structure code (122) is represented by a process number (125) and an item number (126)

FIG. 12 is another example of the work attribute information changing rules referred to when the project is implemented. As seen in FIG. 12. the work attribute information changing rule includes an IF unit (131) for determining a state of a work completed and a THEN unit (132) for performing processing for changing work attribute information if a condition of the IF unit is met.

The work attribute information changing rule shown in FIG. 12 indicates that if “the work quality of the work 2-4 is good”, “the significance degree of the work 5-7 is decreased to 0 and the work 5-7 is deleted”. The processing for changing the attribute information is executed according to the work attribute information changing rules.

When a work is completed during implementation of the project, the “in-implementation” work information comparing unit 36 refers to the work attribute information changing rule data base 22 to determine whether or not attribution information of the work meets a condition of a work attribute information changing rule which is related to the work. Then if the attribution information of the work meets the condition of the work attribute information changing rule, the “in-implementation” work information comparing unit 36 performs processing for changing attribute information of another work according to the work attribute information changing rule. After that, the “in-implementation” work information comparing unit 36 compares the attribute information of the work which is changed with the standard work information. In the example shown in FIG. 12, when the “in-implementation” work information comparing unit 36 compares the attribute information of the work information with the attribute information of the standard work information, it is determined that “the work 5.7 in the process 6 is deleted”, and displays this comparison result on the display device 4 via the “in-implementation” work information output unit 37. An example of a screen structure displayed during implementation of the project is shown in FIG. 14. Details of the screen structure will be explained later.

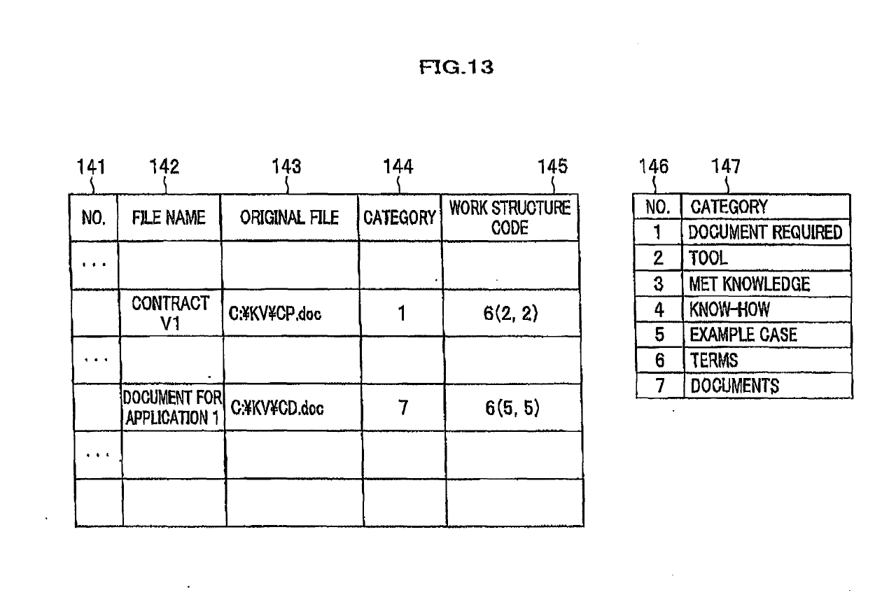

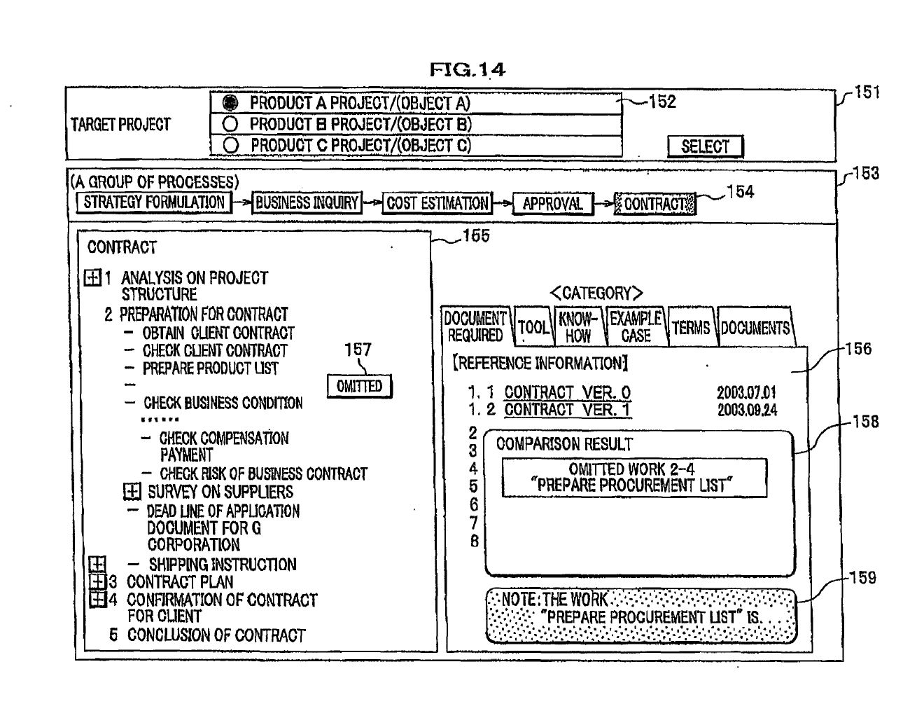

FIG. 13 is another example of the reference information of the work information during implementation of the project. Each piece of the reference information of the work information during implementation of the project is composed of a file number (141), a file name (142), an original file which is shown with its address (143), a category indicating the type of the file (144) (refer to a table which is composed of a category number 146 and a category name (147), and a work structure code (145) indicating which work shown in FIG. 8 is related to the file.

In accordance with the project management support device according to the embodiment of the present invention, the arithmetic processing unit 3 compares work information changed during implementation of the project based on a state of a work completed with the standard work information to classify the work into a necessary work or an unnecessary work and displays the work together with a note regarding the work, whereby it is possible to support the project manager to determine whether or not to add or delete the work while the project is implemented, which contributes to streamlining works of the project and analyzing risk countermeasures.

FIG. 14 is an example of a screen structure displayed by the project management support device according to the embodiment of the present invention when the project is planed.

As seen in FIG. 14, the screen displayed on the display device 4 includes a project selection part (151), a process display part (153), a work information display part (155), a reference information display part (156), a comparison result display part (158), and a note display part (159). In this example, “product A project” (152) is selected in the project selection part (151), and processes in the project are displayed. In this example, “Contract” (154) is further selected among the processes, and work information in the process is displayed (155).

When the “in-planning” work information comparing unit 32 compares work information in the project work plan with the standard work information, the comparison result (e.g. “prepare procurement list” is “omitted” compared with the standard work information (157)) and notes regarding the comparison result (158,159) are displayed.

Thus, it is possible for the project manager to recognize difference between the project work plan information and the standard work information and to determine which work is necessary or unnecessary according to a project target just by checking the screen of the display device 4, whereby it is also made possible for the project manager to change a work flow determined when the project is planed in a flexible manner. The notes displayed in the note display part 159 also contribute to analyzing risk countermeasures.

FIG. 15 is an example of a screen structure displayed by the project management support device according to the embodiment of the present invention while the project is implemented.

As seen in FIG. 15, the screen displayed in the display device 4 includes a project selection part (11), a process display part (163), a work information display part (165), a reference information display part (166), a comparison result display part (169), and a note display part (170). In this example, “product A project” (162) is selected in the project selection part, and processes in the project are displayed. In this example, “Contract” (164) is further selected among the processes, and work information in the process is displayed (155).

When the “in-planning” work information comparing unit 36 compares work information while the project is implemented with the standard work information, the comparison results (e.g. “prepare product list” is “omitted” (167) compared with the standard work information and “check risk of business contract” is “deleted” (168) compared with the standard work information) and notes regarding the comparison result (169,170) are displayed.

Thus, it is possible for the project manager to recognize difference between the work information whose attribute information is changed during implementation of the project and the standard work information, and to determine which work is necessary or unnecessary according to a project target just by checking the screen of the display device 4, whereby it is also made possible for the project manager to change a work flow determined when the project is planed in a flexible manner. The notes displayed in the note display part 159 also contribute to analyzing risk countermeasures.

In accordance with the project management support device according to the embodiment of the present invention, it is possible to support the project manager for determining whether or not to delete, add or change a work in the project both of when the project is planned, and when the project is implemented where progress of the work or a state of the work is dynamically changed, which leads to improve the usability of the project management support device.

In the above explanation, the project management support device according to the embodiment of the present invention is configured as stand-alone, however, the project management support device may be configured by a computer network where each of the input device 1 and the display device 4 is embodied as a remote terminal and each of the storage device 2 and the arithmetic processing unit 3 is embodied as a server.

A project management support method according to the embodiment of the present invention is implemented in the project management support input device 1 which includes the storage device 2, the arithmetic processing unit 3 and the display device 4 as shown in FIG. 1. As shown in FIG. 2, the method allows the arithmetic processing unit 3 to perform a first step of acquiring project work plan information input by operating the input device 1 (S301), a second step of referring to the standard work information database 21 in the storage device 2 to retrieve the standard work information (S302, S303), a third step of comparing the project work plan information with the retrieved standard work information and extracting work information omitted and work information added from a result of the comparison, and displaying the omitted work information and the added work information on the display device 4 (S304), a fourth step of acquiring information on progress of a work or a state of the work input via the input device 1 (S305), a fifth step of referring to the work attribute information changing rule data base 22 in the storage device 2 and, if there is a work attribute information changing rule related to the acquired information on the progress of the work or the state of the work, executing processing for changing attribute information according to the work attribution information changing rule (S306, S307), and a sixth step of comparing work information which is changed based on a result of the processing for changing the attribute information with the standard work information, and displaying the omitted work information, deleted work information and the added work information on the display device (S308).

The third step of the project management support method according to the embodiment of the present invention (S304) includes a step of comparing each piece of the work information in the acquired project work plan information with all pieces of the standard work information to search for the standard work information which corresponds to the acquired work information (S401˜S403), a step of, when it is determined that there is no standard work information which corresponds to the acquired work information by the comparison, displaying the acquired work information as the “added work information” on the display device 4 (S404 to S406) and a step of, when there is the standard work information which does not correspond to any piece of the acquired work information, the standard work information is displayed as the “omitted work information” on the display device 4 (S407˜S409).

In accordance with the project management support method according to the embodiment of the present invention, the arithmetic processing unit 3 compares the work information generated when the project is planned with the standard work information, and displays the difference therebetween, whereby it is possible to support the project manager to determine whether or not to add or omit a work when the project manager plans a project, which contributes to streamlining works in the project and analyzing risk countermeasures.

The arithmetic processing unit 3 also compares work information changed by the work attribute information changing rule based on a state of a work completed during implementation of the project with the standard work information to classify the work into a necessary work or an unnecessary work and displays information on the work together with a note regarding the work, whereby it is possible to support the project manager to determine whether or not to add or delete the work while the project is implemented, which contributes to streamlining works of the project and to analyzing risk countermeasures.

All functions of the functional blocks included in the project management support device according to the present invention may be embodied by software, or at least a part of the functions of the functional blocks may be embodied by hardware. For example, processing performed by the project work plan acquiring unit 31, the “in-planning” work information comparing unit 32, the “in-planning” work information output unit 33, the work progress/work state acquiring unit 34, the work attribute information changing processor 35, the “in-implementation” work information comparing unit 36, and the “in-implementation” work information output unit 37 that constitute the arithmetic processing unit 3 may be embodied by one or a plurality of computer programs or at least a part of the processing may be embodied by hardware. In any case, the standard work information database 21, the work attribute information changing rule data base 22 and the reference information data base 23 are stored in the storage device 2.

The embodiment according to the present invention has been explained as aforementioned. However, the embodiment of the present invention is not limited to those explanations, and those skilled in the art ascertain the essential characteristics of the present invention and cam make the various modifications and variations to the present invention to adapt it to various usages and conditions without departing from the spirit and scope of the claims.

What is claimed is:

1. A project management support device for managing work information on a work in each process in a project and attribute information on the work in the work information, comprising:
an input device for inputting various information;
a storage device for storing standard work information of the project;
a display device; and
an arithmetic processing device for
comparing the work information generated when the project is planned and acquired via the input device with the standard work information stored in the storage device;
extracting added or omitted work information from a result of the comparison, and
displaying the extracted work information on the display device.

2. The project management support device according to claim 1, wherein the storage device stores a work attribute information changing rule which is used when the attribute information in the work information is changed, and
when the project is implemented, the arithmetic processing device refers to the work attribute information changing rule and changes the attribute information in the work information generated when the project is planned, acquired via the input device according to the work attribute information changing rule.

3. A project management support device for managing work information on a work in each process in a project and attribute information on the work in the work information, comprising:
an input device for inputting various information;
a storage device for storing standard work information of the project;
a display device; and
an arithmetic processing device for
comparing the work information changed during implementation of the project based on information on progress or a state of the work acquired by the input device with the standard work information stored in the storage device,
extracting added work information or omitted work information from a result of the comparison, and
displaying the extracted work information on the display device.

4. The project management support device according to claim 1, wherein the storage device stores a work attribute information changing rule is used when the attribute information in the work information is changed, and
when the arithmetic processing device acquires information on progress of a work or a state of the work via the input device, the arithmetic processing device:
refers to the work attribute information changing rule, and
changes the attribute information in the work information according to the work attribute information changing rule.

5. The project management support device according to claim 1, wherein the input device inputs, when the project is planned, information on a process predefined by a user based on a type of the project and information on a work to be carried out in the process, and outputs the input information to the arithmetic processing device.

6. The project management support device according to claim 2, wherein the input device inputs, when the project is planned, information on a process predefined by a user based on a type of the project and information on a work to be carried out in the process, and outputs the input information to the arithmetic processing device.

7. The project management support device according to claim 1, wherein the input device inputs as the attribute information at least one of a work name, a work content, a work structure, a work significance, a work priority, information on progress of a work or a state of the work, and reference information on the work, and outputs the input attribute information to the arithmetic processing device.

8. The project management support device according to claim 2, wherein the input device inputs, as the attribute information, at least one of a work name, a work content, a work structure, a work significance, a work priority, information on progress of a work or a state of the work, and reference information on the work, and outputs the input attribute information to the arithmetic processing device.

9. The project management support device according to claim 3, wherein the input device inputs, as the attribute information, at least one of a work name, a work content, a work structure, a work significance, a work priority, information on progress of a work or a state of the work, and reference information on the work, and outputs the input attribute information to the arithmetic processing device.

10. The project management support device according to claim 4, wherein the input device inputs, as the attribute information, at least one of a work name, a work content, a work structure, a work significance, a work priority, information on progress of a work or a state of the work, and reference information on the work, and outputs the input attribute information to the arithmetic processing device.

11. The project management support device according to claim 5, wherein the input device inputs, as the attribute information, at least one of a work name, a work content, a work structure, a work significance, a work priority, information on progress of a work or a state of the work, and reference information on the work, and outputs the input attribute information to the arithmetic processing device.

12. The project management support device according to claim 6, wherein the input device inputs, as the attribute information, at least one of a work name, a work content, a work structure, a work significance, a work priority, information on progress of a work or a state of the work, and reference information on the work, and outputs the input attribute information to the arithmetic processing device.

13. The project management support device according to claim 3, wherein the input device inputs, as the information on progress or the state of the work, at least one of information indicating whether or not the work is completed, a level of the work quality, and information indicating whether or not there is a document prepared for the work, and outputs the input information to the arithmetic processing device.

14. The project management support device according to claim 4, wherein the input device inputs, as the information on progress or the state of the work at least one of information indicating whether or not the work is completed, a level of the work quality, and information indicating whether or not there is a document prepared for the work, and outputs the input information to the arithmetic processing device.

15. The project management support device according to claim 2, wherein the work attribute information changing rule shows an influence the progress or the state of the work exerts on other works, and the arithmetic processing device performs processing for changing the attribute information in the work information according to the work attribute information changing rule.

16. The project management support device according to claim 4, wherein the work attribute information changing rule shows an influence the progress or the state of the work exerts on other works, and the arithmetic processing device performs processing for changing the attribute information in the work information according to the work attribute information changing rule.

17. The project management support device according to claim 1, wherein the display device displays at least one of a symbol and a message which are predefined by the arithmetic processing device for seeking attention of a user, in addition to the omitted work information and the added work information.

18. The project management support device according to claim 2, wherein the display device displays at least one of a symbol and a message which are predefined by the arithmetic processing device for seeking attention of a user, in addition to the omitted work information and the added work information.

19. A project management support method implemented in a project management support device for managing work information on a work in each process in a project and attribute information on the work in the work information, the device comprising an input device for inputting information, a storage device for storing standard work information of the project and a work attribute information changing rule which is used when the attribute information on the work in the work information is changed, an arithmetic processing device and a display device, the method allowing the arithmetic processing device to perform the steps comprising:
a first step of acquiring a project work plan input via the input device;
a second step of retrieving the standard work information stored in the storage device;
a third step of comparing the project work plan with the standard work information, extracting omitted work information and added work information from a result of the above comparison and displaying the omitted work information and the added work information on the display device;
a fourth step of acquiring information on progress or a state of the work input via the input device;
a fifth step of referring to the work attribute information changing rule based on the acquired information on progress or the state of the work, and performing processing for changing the work information according to the work attribute information changing rule; and
a sixth step of comparing the work information changed by the processing for changing the work information with the standard work information, extracting omitted work information and added work information from a result of the comparison, and displaying the omitted work information and the added work information on the display device.

20. The method according to claim 19, wherein the third step comprises:
a step of comparing each piece of the work information in the project work plan with all pieces of the standard work information and searching for the work information which corresponds to the standard work information;
a step of, if it is determined that there is the work information which does not agree with any piece of the standard work information by the searching, displaying the work information as the added work information on the display device;
a step of, if it is determined that there is the standard work information which does not agree with any piece of the work information, displaying the standard work information as the omitted work information.
